(19) United States
(12) Patent Application Publication
(10) Pub. No.: US 2026/0295621 A1
(43) Pub. Date: Oct. 1, 2026

(54) SPRAYING MODULE AND SELF-PROPELLED AUTONOMOUS MARKING ROBOT

(71) Applicant: TURF TANK APS, Svenstrup J (DK)

(72) Inventors: Kacper TUREK, Svenstrup J (DK); Daniel LASSEN, Svenstrup J (DK)

(73) Assignee: TURF TANK APS, Svenstrup J (DK)

(21) Appl. No.: 19/489,882

(22) PCT Filed: Jun. 7, 2024
(86) PCT No.: PCT/EP2024/065815

§ 371 Date: Dec. 3, 2025

(30) Foreign Application Priority Data
Jun. 9, 2023 (DK) PA202370278

(51) Int. Cl. B05B 13/00; A63C 19/06; B05B 12/34; B05B 12/36; G05D 1/689; G05D 105/00; G05D 107/00

(52) U.S. Cl. CPC B05B 13/005; A63C 19/065; B05B 12/34; B05B 12/36; G05D 1/689; A63C 2019/067; G05D 2105/17; G05D 2107/87

(57) ABSTRACT

The present disclosure provides a spraying module having a proximal side configured for abutting a side of the self-propelled autonomous marking robot when the spraying module is connected to the self-propelled autonomous marking robot and a distal side opposite to the proximal side and configured for facing away from the self-propelled autonomous marking robot, and a self-propelled autonomous marking robot for marking the ground of a sports field.

### TECHNICAL FIELD

The present invention relates to a spraying module for a self-propelled autonomous marking robot for marking the ground of a sports field, and a self-propelled autonomous marking robot.

### BACKGROUND

Playing fields for various sports, including football, soccer, rugby, and other turf-based activities, require clear and accurate line markings on the ground to define boundaries, goal lines, and other essential areas. Traditionally, line markings on playing fields have been created using manual or semi-automated methods employing line marking machines. However, these machines have several limitations.

Conventional line marking machines typically require manual operation and rely on physical measurements, such as tapes or string lines, for alignment. This process can be time-consuming, labour-intensive, and prone to human error, leading to inconsistencies and inaccuracies in the resulting line markings. Moreover, the traditional machines often lack precision control and may struggle to mark straight lines or create sharp turns, negatively impacting the overall appearance and functionality of the playing field.

More recently, attempts have been made to develop advanced line marking machines that address these limitations. Some machines utilize laser-guided or GPS-assisted technologies to enhance accuracy and alignment. While these technologies have shown promise, they still have limitation when it comes to the quality and preciseness of the line markings.

There is thus a need for a solution, which improves the accuracy of a line marking machine, and which preferably also provides ease of use and versatility.

### SUMMARY

According to a first aspect of the invention, this and other objects are achieved with a spraying module having a proximal side configured for abutting a side of the self-propelled autonomous marking robot when the spraying module is connected to the self-propelled autonomous marking robot and a distal side opposite to the proximal side and configured for facing away from the self-propelled autonomous marking robot, where the spraying module comprises: a mechanical connector for engaging in a mechanical connection with the self-propelled autonomous marking robot, the mechanical connector being located at the proximal side of the spraying module; a spraying nozzle comprising a spraying nozzle inlet for receiving marking material and a spraying nozzle outlet for dispersing the marking material into a spraying space; a proximal disc and a distal disc, said proximal disc and said distal disc being arranged on opposite sides of the spraying nozzle and having a width between them to delimit the spraying space; wherein said proximal disc is rotatably attached to a first end of a proximal lift arm by a rotation coupling, and said distal disc is rotatably attached to a first end of a distal lift arm by a rotation coupling; and wherein the proximal lift arm and the distal lift arm are individually pivotable around a pivot axis extending between the proximal side and the distal side, such that said proximal disc and said distal disc can be moved independently of each other.

By allowing the discs to be movable independently of each other, the spraying module is able to compensate for an uneven ground surface, which may aid in producing higher quality markings. By a disc being able to move away from the ground of the playing field it will not be pressed so hard into the ground that it is prevented from rotating, thereby avoiding that the disc drags the deposited marking material along. By a disc being able to move closer to the ground of the playing field it will not lose contact with the ground and will thus prevent marking material from escaping the spraying space in the width direction. The solution may thus lead to sharper edges and more consistent marking material deposition on the ground.

The other components/features of the spraying module aids toward the same advantages. For example, having a proximal side configured for abutting a side of the self-propelled autonomous marking robot, thereby allowing the spraying module to be positioned to the side of a forward direction of the self-propelled autonomous marking robot when driving to avoid the robot having to drive over newly made markings. It is to be understood in the context of this disclosure that proximal elements are located closer towards or at the proximal side of the spraying module relative the distal side. Likewise, distal elements are located closer towards or at the distal side relative the proximal side.

In the use state of the spraying module the spraying space is defined by the physical space located between the proximal disc and distal disc in a horizontally discretion, and from spraying nozzle outlet to ground surface in a vertical direction.

Furthermore, the provision of a mechanical connector for engaging in a mechanical connection with the self-propelled autonomous marking robot allows the spraying module to be removed for cleaning, maintenance, and repairs. This will reduce the risk of a build-up of marking material residue, which may for example block or hinder the rotation of the discs, thereby also contributing to sharper edges and a consistent deposition.

In some embodiments, the said proximal disc and said distal disc are placed symmetrically around the spraying nozzle outlet. The angle of any dispersed marking material that hits each of the discs will then be substantially the same, thereby providing a higher chance of avoiding uneven and excess material deposition over the width of the line marking.

In some embodiments, the spraying module further comprises a connector shaft extending between the proximal side and the distal side and defining the pivot axis. The connector shaft provides a way to connect other components of the spraying module. Further, it may also provide a way to mechanical control other components of the spraying module, e.g. rotation of the lift arms and discs about the pivot axis. The connector shaft may also be useful in adjusting the width between the lift arms and the discs.

In some embodiments, each of a second end of the proximal lift arm and a second end of the distal lift arm is attached to the connector shaft by a lifting arrangement. The lifting arrangement provides the lift arm and hence the disc with the ability of being pivotable independently of each other and of the connector shaft, while at the same time being rotatable by the connector shaft. Hence, the lift arms and discs can pivot around the pivot axis and thereby move to compensate for the ground surface topography, and they can be rotated by the connector shaft, e.g. to be lifted of the ground. The pivot axis may coincide with a longitudinal axis of the connector shaft.

In some embodiments, the lifting arrangement comprises a lifting element and a lifting coupling. The lifting element provides a way for the lift arm and disc to pivot independently of each other and of the connector shaft, by only engaging with the connector shaft via the lifting coupling. the lifting coupling provides a way for the lift arm and disc to be rotatable about the pivot axis, e.g. by rotation of the connector shaft, as the lifting coupling follows the movement of the connector shaft.

For example, the connector shaft may have a square cross section configured to fit a square inner bore of the lifting coupling. That way, rotation of the connector shaft will result in equal rotation of the lifting coupling. The lifting coupling may further comprise one or more fastening elements, such as screws or bolts, extending through an one or more apertures of the lifting element. The apertures provides a degree of movement freedom of the fastening elements before the edge of the apertures and the fastening element engages. Once they have engaged the movement of the lifting coupling will result in identical movement of the lifting element, which in turn is connected to the lift arms and thus translate the movement from the connector shaft and lifting coupling to movement of the lift arms and discs.

The lifting elements thus contribute to the individual pivotability of the lift arms about the pivot axis allows the disc to follow the shape of the ground surface, and the lifting couplings allow a simultaneous lifting or lowering, e.g. in connection with the ending or starting of a line marking process or to allow cleaning, maintenance, or repair. The lifting element and the lifting coupling may be rotatable and/or movable relative to each other. The lifting elements may be connected to a actuator for moving the lifting elements independently of the lifting coupling and/or connector shaft. The lifting elements and/or the lift arms may comprise a handle configured for manual lifting of the lifting elements and/or the lift arms.

In some embodiments, the second end of the proximal lift arm and distal lift arm engages the respective lifting element, the lifting element engages the lifting coupling, and the lifting coupling engages the connector shaft. The lifting element thus provides a way to transfer the rotational movement of the lifting coupling, e.g. initiated by the connector shaft, to a rotational movement of the lifting arm and hence the disc, while at the same time allowing pivotability independently of movement of the lifting coupling.

In some embodiments, the lifting element is independently pivotable around the lifting coupling, the connector shaft, and the pivot axis, and a rotational movement of the lifting element results in the same rotational movement of the respective lift arm. This allows the lifting arms and discs to be independently pivotable around the lifting coupling, the connector shaft, and the pivot axis.

In some embodiments, the lifting coupling is independently rotatable with the connector shaft about the pivot axis, such that a rotational movement of the connector shaft results in the same rotational movement of the lifting coupling. This allows rotational movement of the connector shaft to control the rotation of the lifting coupling, and possibly the lift arm and disc.

In some embodiments, the connector shaft is connected to the mechanical connect-or, thereby providing a way to control movement of the connector shaft, e.g. by in-put from the self-propelled autonomous marking robot or a user. It is also possible for the connector shaft to project into the self-propelled autonomous marking robot and be connected to a control unit therein independently from the mechanical connector.

In some embodiments, the spraying module further comprises a width scale indicating the width between the proximal disc and the distal disc, said width scale preferably extending horizontally in the use state of the spraying module. By pivoting at least one of the proximal disc, the distal disc, the proximal lift arm, and the distal lift arm into engagement with the width scale, a user is provided with an easy and quick way to check, set and adjust the width between the proximal disc and the distal disc without relying on eye measurement of the indicated width only or the use of a separate measuring tool.

In some embodiments, the width scale comprises a plurality of width indication recesses each having a width corresponding to the thickness of at least one of an edge of the proximal disc, an edge of the distal disc, an edge of the proximal arm, and an edge of the distal arm. By having a plurality of width indication recesses each having a width corresponding the thickness of one of these edges, the disc or arm in question may be rotated into contact with the width scale and into a respective recess to clearly establish the width between the lift arms and the discs. It is presently considered advantageous that the width indication recesses are configured for receiving the edges of the disc, as this will provide a direct indication of the width between the discs, independently of the design and state of the lift arms.

In some embodiments, the spraying module further comprises a width adjustment arrangement configured to receive input from a user to adjust the width between the proximal lift arm and the distal lift arm and hence between the proximal disc and the distal disc. The width adjustment arrangement should preferably allow width adjustment while the spraying module is attached to the self-propelled autonomous marking robot.

In some embodiments, the width adjustment arrangement comprises a width adjustment knob attached to a gear, which engages two opposite gear racks, each gear rack being attached to a gear racks holder, which is connected to the second end of a respective one of the proximal lift arm and distal lift arm. The width adjustment thereby allows both lift arms and hence both discs to be moved simultaneously and over the same distance, thereby ensuring that the relative distance of each disc to the spraying nozzle remains the same. The width adjustment knob thus provides an easy way for a user to interact with the width adjustment arrangement, which trans-lates the turning of the width adjustment knob into movement of the lift arms and hence the discs. The movement of the lift arms may be a sliding movement of the second ends of the lift arms along the connector shaft. The gear attached to the width adjustment knob may be a pinion gear.

In some embodiments, the width adjustment knob comprises number of teeth configured to match an equal number of corresponding recesses, such that in a first position of the width adjustment knob the teeth engages and interlocks with the corresponding recesses, and in a second position of the width adjustment knob the teeth are free from the engagement with the recesses, wherein the second position allows for rotation of the width adjustment knob to adjust the width by the width adjustment arrangement.

The width adjustment knob may be biased towards the first position by a biasing element, such as a spring.

The corresponding recesses may be provided in the spraying module cover, such as in an width adjustment aperture configured in dimension to allow engagement with the width adjustment knob and interlocking between the number of teeth and corresponding recesses. This provides a way to secure that the width adjustment knob maintains its position once a desired with setting has been chosen, as the interlocking limits the width adjustment knobs ability to turn without manual interference by a user.

The provision of teeth on the width adjustment knob has been found to be advantageous due to the risk of displacement of the width adjustment arrangement during use. For example due to vibrations in the spraying module and movements of the proximal and distal lift arms and discs from traveling over an uneven or rough ground surface.

In some embodiments, the spraying module further comprises a height adjustment arrangement configured to receive input from a user to adjust a height of the spraying nozzle relative to the surface to be marked. Thereby allowing a user to set and adjust the height of the spraying nozzle, e.g. to achieve a more concentrated deposition of marking material or to give room for the grass when operating on turf. The height of the spraying nozzle may be measured relative the ground surface. Alternatively, or additionally, the height of the spraying nozzle may be measured relative other components of the spraying module, such as the connector shaft or a spraying module cover.

In some embodiments, the height adjustment arrangement comprises a height scale extending vertically in the use state of the spraying module. Thereby providing an easy and reliable way for a user to check, set and adjust the height of the spraying nozzle. The height scale may comprise numbers, symbols, markings, or any combination thereof.

In some embodiments, the spraying nozzle is attached to a first part of height adjustment arrangement, which is in turn connected to a second part of height adjustment arrangement in a manner such that the first part is moveable relative to the second part in a height direction. The second part may be provided with a series of openings and the first part may be provided with at least one male member fitting into said openings, such that a height of the spraying nozzle may be decided by engaging the male member with one of the openings. It is also possible to provide the male member on the second part and the openings on the first part. The male member may be spring loaded towards an extended position, so that the spring force will have to be overcome to release the male member from an opening and release the first part from the second part. The openings may alternatively be provided in the first part and the male member(s) on the second part.

The first part may be detachable from the second part so that the first part and the spraying nozzle may be taken off the spraying module, e.g. for cleaning, repair, or replacement of the spraying nozzle. Alternatively, or additionally, the entire height adjustment arrangement may be detachable from the rest of the spraying module.

An additional or further height adjustment may be provided by the second part being displaceable in the height direction, e.g. by attaching it to a threaded spindle, which may be raised or lowered by turning a height adjustment knob engaging with the spindle, thus providing a stepless height adjustment. Other a threaded or toothed devices, such as gear wheels or racks, or devices relying on friction may also be used for achieving a stepless height adjustment. Alternatively, or additionally, the height adjustment arrangement may be configured for allowing a stepless height adjustment of the first part in relation to the second part.

The spraying module may further be provided with a water inlet configured for connection to a water supply. This may allow rinsing of the spraying nozzle at intervals or when deemed necessary.

According to a second aspect of the invention, there is further provided a self-propelled autonomous marking robot for marking the ground of a sports field, the self-propelled autonomous marking robot comprising a propulsion system, at least one drive wheel connected to the propulsion system, at least one additional wheel, a reservoir configured to contain a marking material, a dispensing system comprising tubing and at least one actuator, the dispensing system being configured to move marking material from the reservoir to an outlet of the tubing, a control system comprising a Central Processing Unit (CPU) and a memory and configured to controlling the dispensing system, and a spraying module according to the first aspect, configured to receive the marking material from the outlet of the tubing. Such a self-propelled autonomous marking robot will benefit from the advantages described with reference to the first aspect of the invention. Specifically, a self-propelled autonomous marking robot with a spraying module according to the first aspect together, may provide a more precise, clear, and consistent way of marking a ground surface, and may provide an increased usability for a user of the self-propelled autonomous marking robot. Marking material may be supplied directly to the reservoir. Alternatively, the reservoir may be of a replaceable container type, such that the whole reservoir is changed when changing marking material.

The self-propelled autonomous marking robot may utilize a range of sensors to gather information about the playing field. These sensors may include but are not limited to GPS sensors, vision systems, and distance sensors. Further, the self-propelled autonomous marking robot comprises a control system comprising a Central Processing Unit (CPU) for executing control algorithms and coordinating the various subsystems. During operation, the control systems of the self-propelled autonomous marking robot may utilize information from the sensors to navigate and traverse a playing field or the like, calculate precise positioning, adjusts its speed and direction, and marking lines according to predefined parameters while adjusting its marking mechanisms in real-time, ensuring accurate and consistent line markings.

These components and systems are well known to the skilled person and will therefore not be described in further detail here.

In some embodiments, the self-propelled autonomous marking robot further comprises a mechanical connector, which is releasably connectable to the mechanical connector of the spraying module. This provides a way to easily exchange spraying module of the self-propelled autonomous marking robot, or simply an easy way to detach and reconnected a spraying module from and to the self-propelled autonomous marking robot e.g., when cleaning, maintaining, or changing components of the spraying module.

In some embodiments, the control system is configured to lift or lower the discs of the spraying module by controlling an actuator to rotate the lift arms about the pivot axis, e.g. by rotation of a connector shaft and/or by activating a lifting arrangement. Thereby autonomous control of lifting or lowering the discs of the spraying module, e.g. when initiation or ending of a line marking job, may be provided.

In some embodiments, the actuator is configured for rotating the connector shaft of the spraying module to rotate the lift arms, thereby providing a way for the self-propelled autonomous marking robot to mechanically control lifting or lowering of the lift arms.

In some embodiments, the actuator is directly connected to and configured to move at least one of the proximal and distal lift arm. The actuator may be controlled via wired or wireless communication with the control system.

While reference is made primarily to the spraying module and the self-propelled autonomous marking robot being used for creating line markings on playing fields, it is to be understood that this is just one example of a surface on which line markings can be made. As another example, the spraying module and the self-propelled autonomous marking robot can be used for painting temporary parking slots, tent pitches or the like. Likewise, the reference to line markings does not exclude that the spraying module and the self-propelled autonomous marking robot can be used for painting numbers or letters, or for other marking operations, such as the painting of company names, logos, slogans, or works of art.

Any embodiment, part of embodiment, method, or part of method described above may be combined in any applicable way.

### BRIEF DESCRIPTION OF THE DRAWINGS

The invention will now be described, by way of example, with reference to the accompanying drawing, in which:

FIG. 1a shows an embodiment of a spraying module connected to a self-propelled autonomous marking robot in an elevated perspective view from the right.

FIG. 1b shows the spraying module and self-propelled autonomous marking robot of FIG. 1a in a top view.

FIG. 2a shows an embodiment of a spraying module in an elevated perspective view from the right.

FIG. 2b shows an embodiment of a spraying module in an elevated perspective view from the right.

FIG. 2c shows the spraying module of the embodiment of FIG. 2b in a side view from the right.

FIG. 2d shows the spraying module of the embodiment of FIG. 2b in a side view from the right.

FIG. 2e shows the spraying module of the embodiment of FIG. 2b in a side view from the right.

FIG. 3 shows an embodiment of a width adjustment arrangement of a spraying module in a top view.

FIG. 4a shows an embodiment of a lifting coupling of a lifting arrangement of a spraying module in a side view from the right.

FIG. 4b shows a cross-sectional view II-II of the embodiment of FIG. 4a.

FIG. 4c shows an embodiment of a lifting element of a lifting arrangement of a spraying module in a side view from the right.

FIG. 5a-e shows a stepwise lifting process of an embodiment of a lifting element of a lifting arrangement of a spraying module in a side view from the left.

FIG. 6 shows an embodiment of a distal lift arm and distal disc of a spraying module in a side view from the left.

FIG. 7 shows a spraying module corresponding to that in FIG. 2b in an elevated perspective view from the right, wherein the proximal and distal discs are in a lifted position and the distal disc is brough into engagement with a width indication recess of the width scale.

FIGS. 8a and 8b shows an embodiment of a width adjustment knob of a spraying module in perspective views.

### DETAILED DESCRIPTION

In the following a detailed description of embodiments of the invention will be given with reference to the accompanying drawings. It will be appreciated that the drawings are for illustration only and are not in any way restricting the scope of the invention. Thus, any references to directions, such as “up” or “down”, are only refer-ring to the directions shown in the figures. It should be noted that the features having the same reference numerals have the same function, a feature in one embodiment could thus be exchanged for a feature from another embodiment having the same reference numeral unless clearly contradictory. The descriptions of the features having the same reference numerals should thus be seen as complementing each other in describing the fundamental idea of the feature and thereby showing the features versatility.

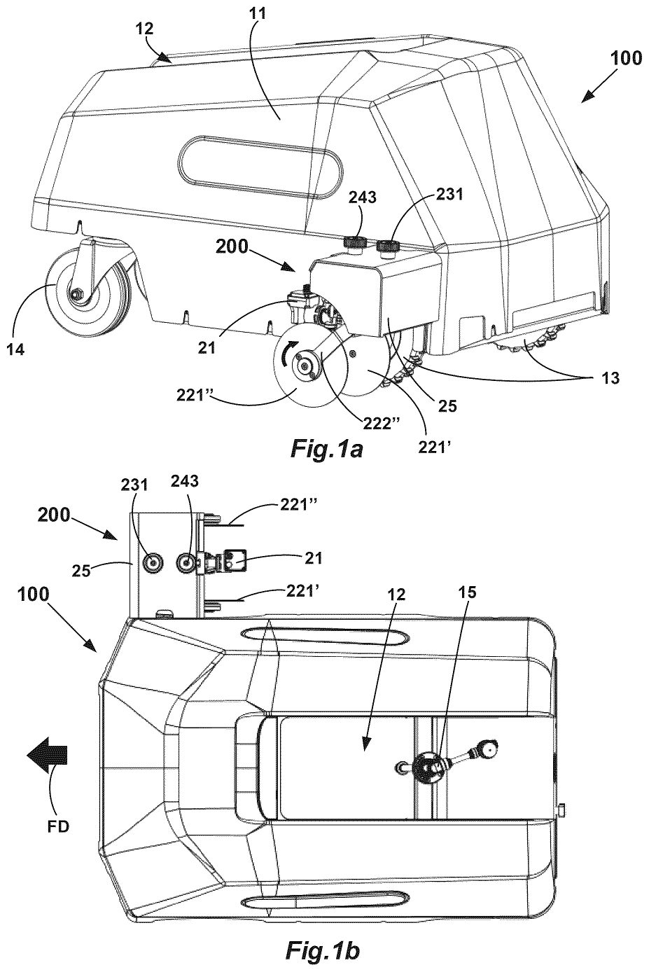

FIGS. 1a and 1b shows an embodiment of a self-propelled autonomous marking robot 100 comprising a housing 11, a reservoir 12 for holding a marking material, such as paint or chalk, two drive wheels 13, two castor wheels 14, and a spraying module 200. To protect the components of the spraying module 200, a spraying module cover 25 is provided, shielding off the top of the spraying module 200 and the side facing in the forward direction FD when the self-propelled autonomous marking robot 100 is in operation.

The drive wheels 13 are connected to a propulsion system, e.g. an electrical motor and are robust wheels that enable smooth and stable movement across different terrains while ensuring optimal maneuverability during line marking operations. In the shown embodiment the drive wheels 13 are in front of the self-propelled autonomous marking robot 100, defined by the forward direction FD of the self-propelled autonomous marking robot 100. The castor wheels 14 are mounted in the rear of the self-propelled autonomous marking robot 100 and follow the movement of the drive wheels 13. All the wheels 13, 14 are attached to a chassis (not visible).

The housing 11 houses various components and systems, including sensors and control systems. The self-propelled autonomous marking robot 100 utilizes a range of sensors to gather information about the playing field, and control systems (not visible) such as a Central Processing Unit (CPU) for executing control algorithms and coordinating the various subsystems, may utilize information from the sensors.

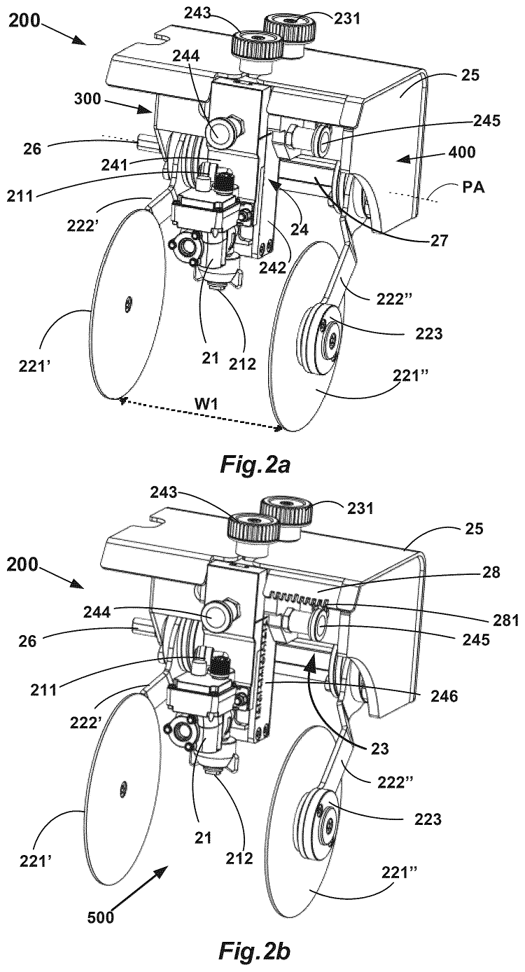

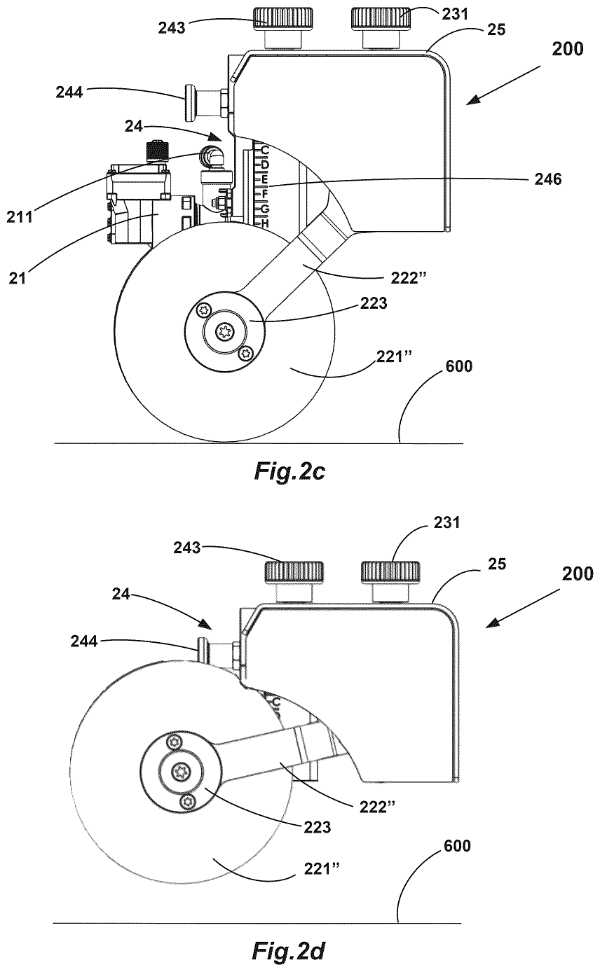

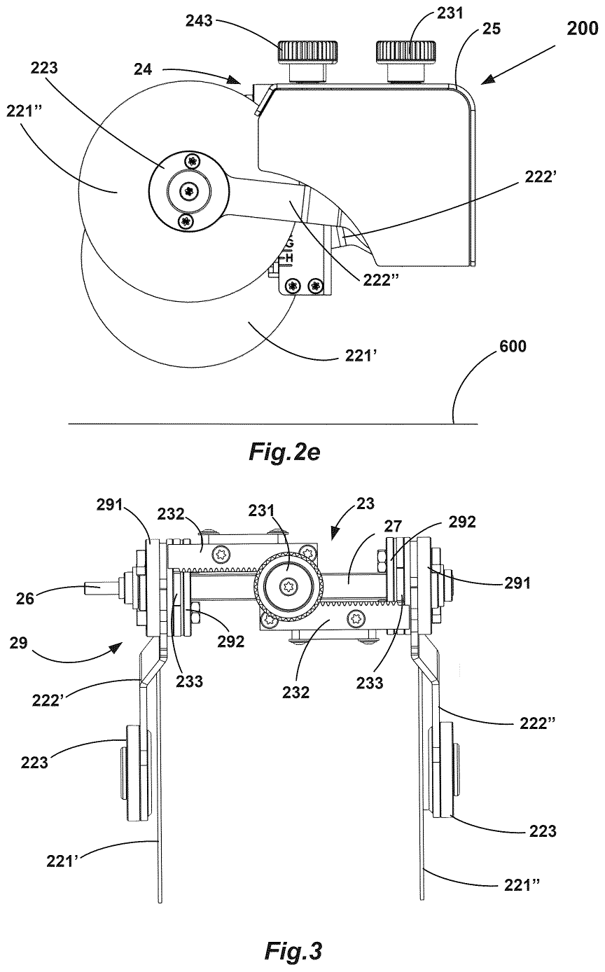

The spraying module 200, which is shown in more detail in FIGS. 2a, 2b, and 2c, is re-sponsible for accurately depositing line markings with a consistent line width and deposition, resulting in clear and visible markings on a playing field or a similar ground surface 600. The spraying module 200 comprises a spraying nozzle 21, which is arranged between a proximal disc 221′ and a distal disc 221″.

The spraying nozzle 21 is connected to a dispensing system inside the housing 11, said dispensing system being configured to supply marking material to a spraying nozzle inlet 211 of the spraying nozzle. The marking material may include biodegradable paints, chalk, or environmentally friendly alternatives. The dispensing system is driven by actuators that control the dispensing process. These actuators may include motors, valves, or pneumatic systems, regulating the flow and deposition of the marking material by pumping marking material from the reservoir 12 through tubes, including a reservoir tube 15 (seen in FIG. 1b), to the spraying nozzle 21, from which the marking material is sprayed out and deposited on to the ground. The actuators may be controlled by the control system.

The discs 221′, 221″ cover the sides of the spraying nozzle 21 to delimit a spraying space 500 having a width W1 and thus set a limit on the spreading of the dispersed marking material, thereby contributing to defining the width of the line marking as well as the sharpness/quality of the edge of the line marking. The width W1 may be adjusted by operation of a width adjustment knob 231 located on top of the spraying module 200 as will be described in further detail below.

Each of the proximal disc 221′ and distal disc 221″ are rotatably attached to a respective first end of the proximal lift arm 222′ and distal lift arm 222″ by a rotation coupling 223, so that the discs 221′, 221″ may roll on the ground surface 600. The rolling will minimize the amount of marking material being dragged along in the forward direction FD and, hence, contribute to the sharpness of the line marking's edges. To further compensate for unevenness in the ground surface, the lift arms 222′, 222″ are individually pivotable around a pivot axis PA. This will result in the discs being able to move vertically up and down independently of each other to compensate for unevenness, such as holes, bumps, and small obstacles in/on the ground surface. The mechanics of the rotatability of the discs and pivot mechanisms will be discussed further below.

The spraying module 200 further comprises a mechanical connector 26 for engaging in a mechanical connection with a matching mechanical connector of the self-propelled autonomous marking robot 100. The mechanical connector 26 protrudes from a proximal side 300 of the spraying module 200 configured to abut the self-propelled autonomous marking robot 100 when the spraying module 200 is connected to the self-propelled autonomous marking robot 100. Opposite and distal to the proximal side is a distal side 400 being configured for facing away from the self-propelled autonomous marking robot 100 when the spraying module 200 is connected to the self-propelled autonomous marking robot 100.

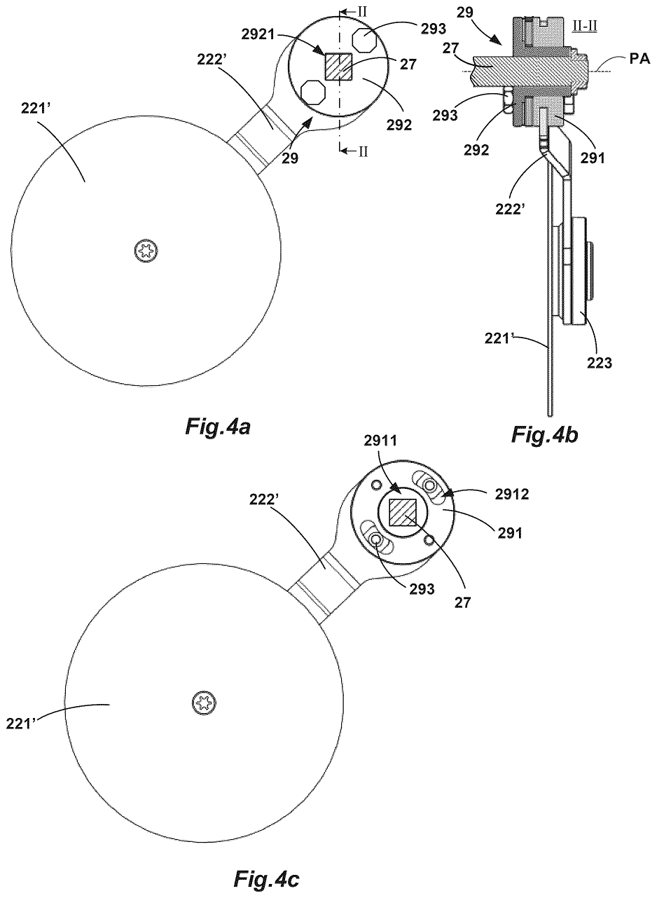

In the shown embodiment the mechanical connector 26 forms part of a connector shaft 27. The connector shaft 27 extends between the proximal side 300 and the distal side 400 within the spraying module 200 under the spraying module cover 25 and each of the proximal lift arm 222′ and the distal lift arm 222″ is attached to the connector shaft such that they can be pivoted simultaneously by rotating the connector shaft. The connector shaft 27 thus defines the pivot axis PA. Here the second ends of the proximal lift arm 222′ and the distal lift arm 222″ are attached independently to the connector shaft 27 by a lifting arrangement 29, shown in FIG. 3 and 4a-c. The independent pivot connection of the proximal lift arm 222′ and the distal lift arm 222″ to the connector shaft means that the proximal disc 221′ and distal disc 221″ can move independently of each other. The lifting arrangement 29 will be discussed further with reference to FIG. 4a-4c.

The spraying module 200 further comprises a width adjustment arrangement 23 located under the spraying module cover 25 (hence not visible in FIG. 2a-2e), an example of which is shown in detail in FIG. 3, for adjusting the width W1 between the proximal disc 221′ and the distal disc 221″, and a height adjustment arrangement 24 for adjusting the height of the spraying nozzle 21 relative to the ground surface 600.

The width adjustment arrangement 23, which will be described in further detail below, is configured to receive input from a user to adjust the width W1 between the proximal disc 221′ and the distal disc 221″, here by operation of a width adjustment knob 231. In the embodiments shown, the proximal disc 221′ and distal disc 221″ are placed symmetrically around the spraying nozzle outlet 212, and any width adjustment will result in equal movement of both the discs 221′, 221″ to maintain the symmetry.

The height adjustment arrangement 24 is configured to receive input from a user to adjust a height of the spraying nozzle 21 relative to the ground surface. The spraying nozzle 21 is attached to the height adjustment arrangement 24, which is here a modular component that can be removed and replaced on the spraying module 200. The height adjustment arrangement 24 connects to and is fastened to the spraying module 200 by an attachment bolt 245.

The height adjustment arrangement 24 provides two possibilities for adjusting the height of the spraying nozzle 21.

The first possibility is a coarse adjustment using the height adjustment index bolt 244, which can set the height of a first part 241 of the height adjustment arrangement 24 relative to a second part 242 of the height adjustment arrangement 24. The index bolt 244 serves as a male member engagement with a series of openings (not visible) in the second part 242, each opening corresponding to one height setting. The spraying nozzle 21 is attached to the first part and may hence be moved closer to or away from the ground surface 600 together with the first part 241 of the height adjustment arrangement 24. A height scale 246 that extends vertically in the use state of the spraying module 200 indicates a relative height relative to the ground surface. The symbols on the height scale do not necessary reflect a true measurement to the ground surface, but rather provide an easy way to adjust and/or readjust the height, e.g. after the spraying nozzle 21 has been cleaned. In the current illustration the numbers A-H, together with scale identifiers have been chosen for the purpose, but any kind of scale fulfilling the same purpose is conceivable within the scope of the invention.

The second possibility is a fine adjustment via the height adjustment knob 243, which can be turned for a small stepless movement of the first part 241 of the height adjustment arrangement 24 relative to the height chosen using the index bolt 244. In the embodiment shown, the height adjustment knob 243 is connected to a threaded spindle (not visible), which projects into and engages a threaded bore (not visible) in the first part 241. As the spraying module cover 25 prevents the first part from rotating about its own height axis, a turning of the height adjustment knob 243 will result in the first part being raised or lowered. The pitch of the thread of the spindle and of the bore will determine the extent of the movement of the first part.

The embodiment in FIGS. 2b-2e differs from that in FIG. 2a only in that it further comprises a width scale 28 that extends horizontally in the use state of the spraying module 200, i.e. when connected to the self-propelled autonomous marking robot 100. The width scale 28 comprises a plurality of width indication recesses 281 to indicate the width W1 between the proximal disc 221′ and the distal disc 221″. Each recess has a width corresponding to the thickness of the edge of the distal disc 221″ so that the distal disc 221″ may be brought into engagement with the width indication recesses 281 to clearly indicate the width W1. As described with reference to the height scale 246, the width scale may be provided with symbols and/or scale identifiers.

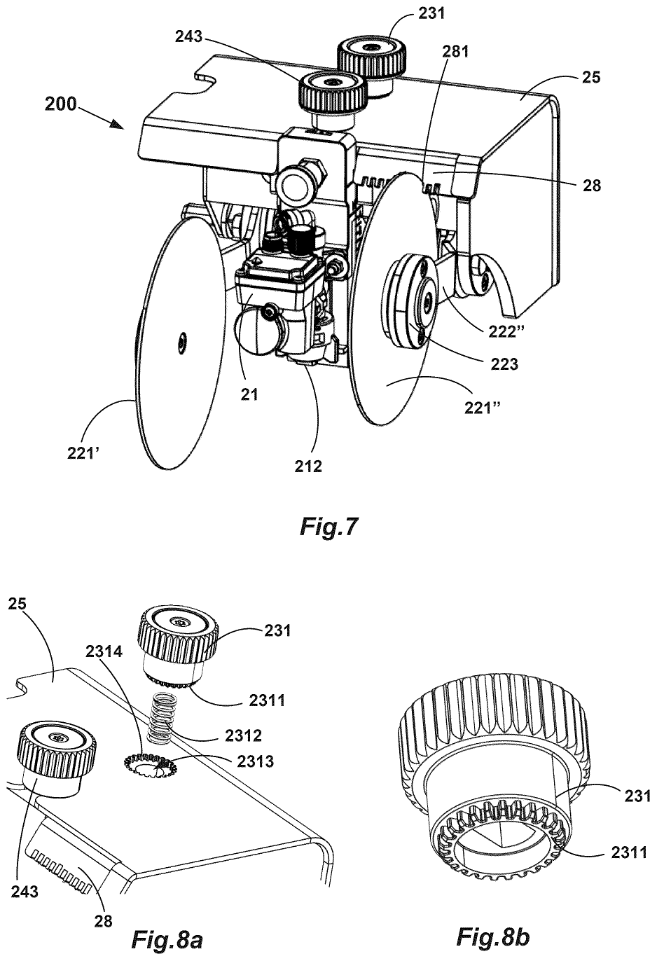

FIGS. 2d and 2e shows the distal disc 221″ lifted from the ground surface 600 and brough into contact with one of the width indication recesses 281 of the width scale 28. In FIG. 2d both the proximal disc 221′ and the distal disc 221″ are lifted equally from the ground surface 600 by rotation of the connector shaft 27, and in FIG. 2e the distal disc 221″ is further pivoted, e.g., manually or by an actuator in the spraying module, from the lifted position shown in FIG. 2d up to a position where it engages one of the width indication recesses 281. The engagement is further illustrated in a perspective view in FIG. 7. The specific lifting mechanism is described more in detail in relation to FIG. 4a-c and 5a-e.

The width scale 28 is here provided at the distal side 400, where it is most easily seen when the spraying module 200 is mounted on the self-propelled autonomous marking robot 100, but it is to be understood that it could be at the proximal side 300, or that a width scale could be provided at both sides.

FIG. 3 shows the detailed implementation of the width adjustment arrangement 23 also described with reference to the previous figures. The width adjustment arrangement 23 comprises the width adjustment knob 231, which is located on top of the spraying module cover 25. The width adjustment knob 231 is attached to a toothed gear (not visible), which engages the teeth of two opposite gear racks 232. Each of the gear racks 232 are attached to a gear racks holder 233, being connected to the second end of a respective one of the proximal lift arm 222′ and distal lift arm 222″. When the gear racks 232 are moved by the turning of the width adjustment knob 231, the gear racks holder 233 will slide along the connector shaft 27 and move the lift arms 222′, 222″ along accordingly. By turning the width adjustment knob 231, the proximal and distal arms 222′, 222″ can thus be moved closer together or further apart, i.e. decreasing or increasing the width W1 of the spraying space 500 between the proximal and distal discs 221′, 221″.

FIG. 4a-4c show more detailed views of the lifting arrangement 29, which comprises a lifting element 291 and a lifting coupling 292. The lifting arrangement 29 is identical for the proximal and distal side of the spraying module 200, only mirror-inverted, and will only be explained in relation to the shown proximal side components of the spraying module 200.

The lifting element 291 is connected to the proximal lift arm 222′ and engages the lifting coupling 292, thereby creating a bridge or indirect connection between the proximal lift arm 222′ and the lifting coupling 292. The lifting element 291 is independently pivotable around the lifting coupling 292 and the connector shaft 27, meaning that it may pivot around the pivot axis PA, while the lifting coupling 292 and the connector shaft 27 are stationary. The lifting element 291 may thereby allow the proximal lift arm 222′ and the proximal disc 221′ to pivot around lifting coupling 292, the connector shaft 27, and the pivot axis PA.

In the embodiment shown, the lifting element 291 comprises a central pivot aperture 2911 having a larger diameter than a diameter of the excircle of the connector shaft 27, such that the lifting element 291 and the connector shaft 27 do not engage each other. The central pivot aperture 2911 are at the same time configured to sur-round and engage at least a portion of the lifting coupling 292, such that it can pivot or slide in a rotational manner around the lifting coupling 292. The lifting coupling 292 here comprises a bushing with a rounded surface that projects into and contacts the inner surface of central pivot aperture 2911, but it could also comprise a bearing, such as a ball bearing or the like.

The lifting coupling 292 is configured to engage at least a portion of the connector shaft 27 and comprises a central rotation aperture 2921 having a geometry corresponding to the cross-section of the portion of connector shaft 27 which engages the lifting coupling 292, such that a rotational movement of the connector shaft 27 results in the same rotational movement of the lifting coupling 292. Here the central rotation aperture 2921 is square.

The lifting arrangement 29 further comprises fastening elements 293, which keeps the lifting coupling 292 and the lifting element 291 together along the direction of the connector shaft 27. The fastening elements 293 further functions as a means for rotating the lift arms 222′, 222″ further than the extent of their pivotable movement. The fastening elements 293 connects to the lifting coupling 292, while extending through curved elongate apertures 2912 in the lifting element 291. The circumferential rotation apertures 2912 allow the lifting element 291 to move within a certain range without engaging the fastening elements 293, thereby allowing the lifting element 291, the lift arms 222′, 222″, and the discs 221′, 221″ to pivot around the pivot axis PA within this range. When it is desired to rotate the discs 221′, 221″ more than the pivotable range, e.g. to bring one or both of the lift arms 222′, 222″ or the discs 221′, 221″ into engagement with the width indication recesses 281, the connector shaft 27 can be rotated. This will rotate the lifting coupling 292 and hence the fastening elements 293, which will engage the ends of the curved elongate apertures 2912 and then move the lifting element 291 along with them in the rotational direction. In other words, the curved elongate apertures 2912 allow each lift arms 222′, 222″ to pivot within the range defined by the length of the curved elongate apertures without movement of the connector shaft 27, so that each disc 221′, 221″ may move independently in response to unevenness in the ground surface.

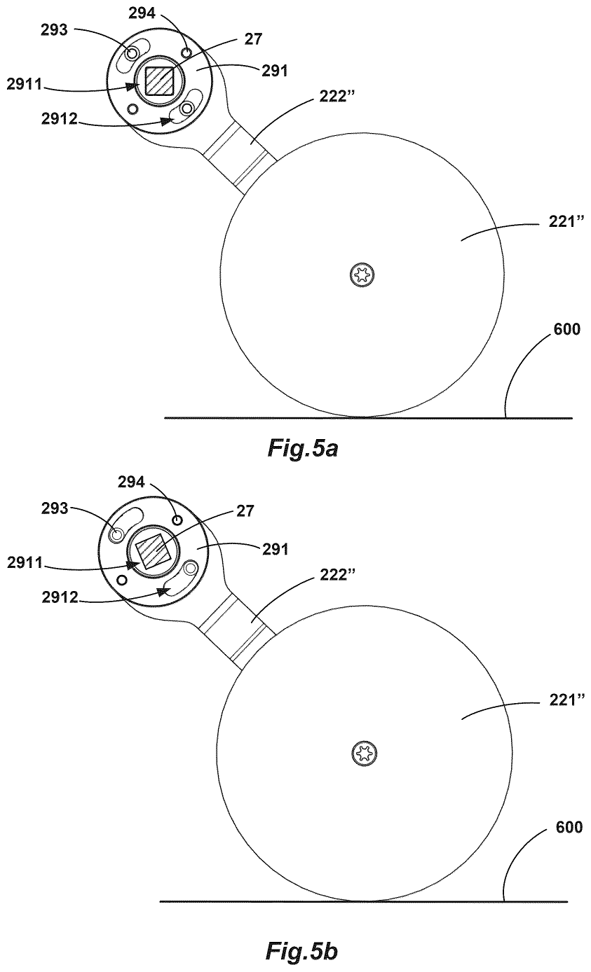

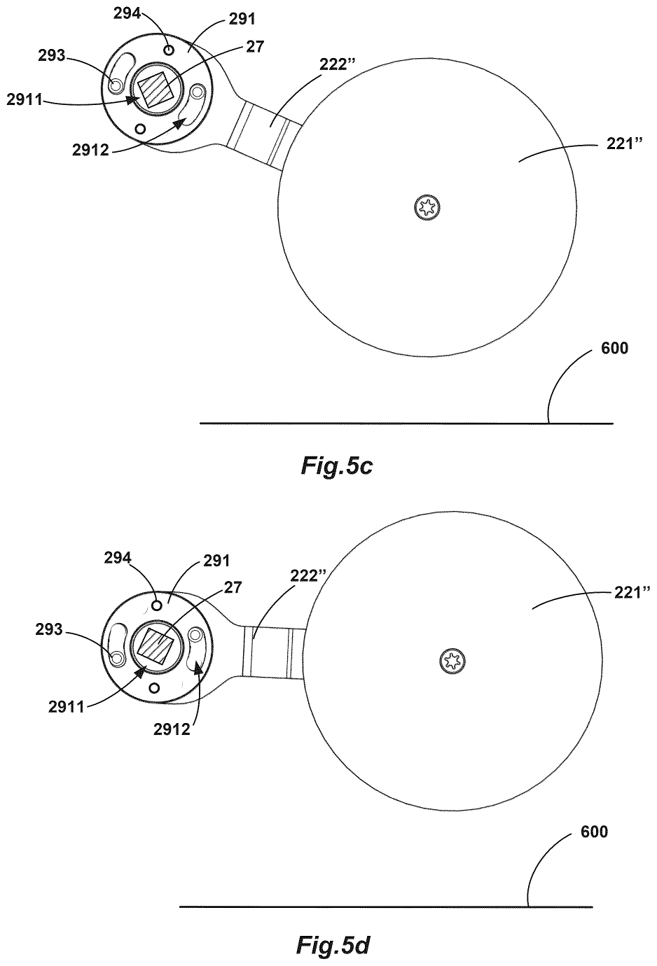

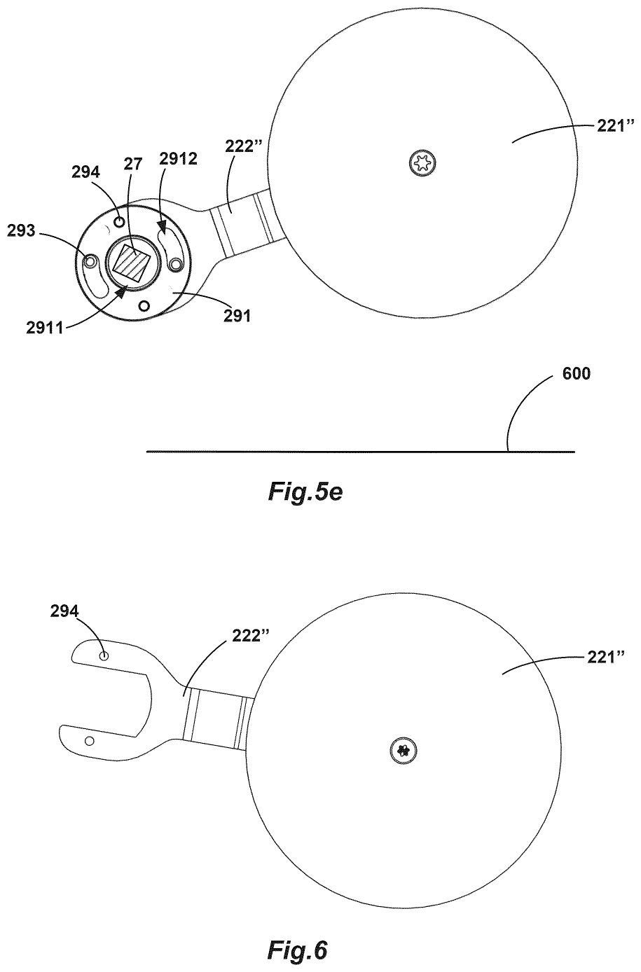

The FIGS. 5a-5e shows in a step wise illustration how the lifting arrangement 29 functions to allow for free independent pivotability of the proximal and distal disc 211′, 221″, respectively, common rotatability for lifting both discs from the ground surface 600, and further pivotability of the disc from their lifted position. FIG. 5a-5e is described in relation to the distal lift arm 222″ and distal disc 221″, but the mechanism of the lifting arrangement 29 works in the same manner for both the proximal and distal side of the spraying module 200.

FIG. 5a shows the distal lift arm 222″ and distal disc 221″ in its neutral position in contact with the ground surface 600. In this position the elongate aperture 2912 allows for free movement of the fastening element 293 within the elongate aperture 2912 and thus allows the distal lift arm 222″ and distal disc 221″ to pivot up and down to provide a way for the distal lift arm 222″ and distal disc 221″ to compensate for an uneven and/or rough ground surface 600.

In FIG. 5b the connector shaft 27 has started to rotate counter clockwise to bring the fastening elements 293 to one end of the elongate aperture 2912. In this position the distal disc 221″ has not been lifted yet and is still in contact with the ground surface 600. FIG. 5c illustrates a further counter clockwise rotation of the connector shaft 27. Once the fastening elements 293 have reached the end of the elongate apertures 2912 any further rotation of the connector shaft 27 will result in the fastening elements 293 force the lifting element 291 to rotate and thus lift the distal lift arm 222″ and distal disc 221″ from the ground surface.

FIG. 5d show the distal lift arm 222″ and distal disc 221″ lifted to a horizontal position approximately in parallel to the ground surface 600. From the position shown in FIG. 5d, the length of the elongate aperture 2912 allows the distal lift arm 222″ and distal disc 221″ to be pivoted to a further height from the ground surface 600, to e.g., be brought into engagement with the width scale 28, as shown in FIGS. 2e and 7.

FIG. 6 show an embodiment of the distal lift arm 222″ and distal disc 221″, to clearly illustrate the connection between the distal lift arm 222″ and the lifting element 291 by the fastening element 294.

FIGS. 8a and 8b shows an embodiment of a width adjustment knob 231 of the spraying module 200. The bottom of the width adjustment knob 231 is provided with a number of teeth 2311 which matches and correspond to an equal number of recesses 2314 of an width adjustment aperture 2313 in the spraying module cover 25 such that width adjustment knob 231 can be locked in place in the width adjustment aperture 2313 by interlocking between the teeth 2311 and recesses 2314. The width adjustment knob 231 may be biased towards engagement with the width adjustment aperture 2313 by a biasing element 2312, such as a spring.

The configuration of the width adjustment knob 231 provides a security for the width setting between the proximal and distal discs 221′, 221″, as the interlocking between the teeth 2311 and recesses 2314 prevents the width adjustment knob from rotating once a desired width setting has been selected. To set the width between the proximal and distal discs 221′, 221″, the width adjustment knob 231 has to be lifted out of its engagement with the width adjustment aperture 2313 and turned to the preferred width setting. After setting, the width adjustment knob 231 is biased into engagement with the width adjustment aperture 2313 by the biasing element 2312 and thus the teeth locks the width adjustment knob 231 in position by interlocking with the recesses 2314 of the width adjustment aperture 2313.

The different aspects or any part of an aspect or different embodiments or any part of an embodiment may all be combined in any possible way. Any method or any step of method may be seen also as an apparatus description, any apparatus embodiment, aspect, or part of aspect or part of embodiment may be seen as a method description, and all may be combined in any possible way down to the smallest detail. Any detailed description should be interpreted in its broadest outline as a general summary description, and please note that any embodiment or part of embodiment as well as any method or part of method could be combined in any way. All examples herein should be seen as part of the general description and therefore possible to combine in any way in general terms.
100 Self-propelled Autonomous Marking Robot
11 Housing
12 Reservoir
13 Drive wheel
14 Castor wheel
15 Reservoir tube
200 Spraying module
21 Spraying nozzle
211 Spraying nozzle inlet
212 Spraying nozzle outlet
221′ Proximal disc
221″ Distal disc
222′ Proximal lift arm
222″ Distal lift arm
223 Rotation coupling
23 Width adjustment arrangement
231 Width adjustment knob
2311 Teeth
2312 Biasing element
2313 Width adjustment aperture
2314 Recesses
232 Gear rack
233 Gear rack holder
24 Height adjustment arrangement
241 First part of height adjustment arrangement
242 Second part of height adjustment arrangement
243 Height adjustment knob
244 Height adjustment index bolt
245 Attachment bolt
246 Height scale
25 Spraying module cover
26 Mechanical connector
27 Connector shaft
28 Width scale
281 Width indication recess
29 Lifting arrangement
291 Lifting element
2911 Central pivot aperture
2912 Elongate aperture
292 Lifting coupling
2921 Central rotation aperture
293 Fastening element
294 Fastening element
300 Proximal side
400 Distal side
500 Spraying space
600 Ground surface
PA Pivot axis
FD Forward direction
W1 Width

1. A spraying module for a self-propelled autonomous marking robot for marking the ground of a sports field, the spraying module having a proximal side configured for abutting a side of the self-propelled autonomous marking robot when the spraying module is connected to the self-propelled autonomous marking robot and a distal side opposite to the proximal side and configured for facing away from the self-propelled autonomous marking robot, where the spraying module comprises:
a mechanical connector for engaging in a mechanical connection with the self-propelled autonomous marking robot, the mechanical connector being located at the proximal side of the spraying module,
a spraying nozzle comprising a spraying nozzle inlet for receiving marking material and a spraying nozzle outlet for dispersing the marking material into a spraying space,
a proximal disc and a distal disc, said proximal disc and said distal disc being arranged on opposite sides of the spraying nozzle and having a width between them to delimit the spraying space, wherein
said proximal disc is rotatably attached to a first end of a proximal lift arm by a rotation coupling, and said distal disc is rotatably attached to a first end of a distal lift arm by a rotation coupling, and wherein
the proximal lift arm and the distal lift arm are individually pivotable around a pivot axis extending between the proximal side and the distal side, such that said proximal disc and said distal disc can be moved independently of each other.

2. A spraying module according to claim 1, wherein each of a second end of the proximal lift arm and a second end of the distal lift arm is attached to a connector shaft by a lifting arrangement.

3. A spraying module according to claim 2, wherein the lifting arrangement comprises a lifting element and a lifting coupling, where the second end of the proximal lift arm and distal lift arm engages the lifting element, and the lifting element engages the lifting coupling, and the lifting coupling engages the connector shaft.

4. A spraying module according to claim 3, wherein the lifting element is independently pivotable around the lifting coupling, the connector shaft and the pivot axis, and wherein a rotational movement of the lifting element results in the same rotational movement of the respective one of the proximal lift arm and the distal lift arm.

5. A spraying module according to claim 3, wherein the lifting coupling is dependently rotatable with the connector shaft about the pivot axis, such that a rotational movement of the connector shaft results in the same rotational movement of the lifting coupling.

6. A spraying module according claim 1, further comprising a width scale indicating the width between the proximal disc and the distal disc, said width scale extending horizontally in the use state of the spraying module.

7. A spraying module according to claim 6, wherein the width scale comprises a plurality of width indication recesses, each having a width corresponding the thickness of at least one of an edge of the proximal disc, an edge of the distal disc, an edge of the proximal arm, and an edge of the distal arm, and wherein at least one of the proximal disc, the distal disc, the proximal lift arm, and the distal lift arm can be brought into engagement with the width indication recesses.

8. A spraying module according to claim 1, further comprising a width adjustment arrangement configured to receive input from a user to adjust the width between the proximal disc and the distal disc, wherein the width adjustment arrangement comprises two opposite gear racks, each gear rack being attached to a gear racks holder which is connected to the second end of a respective one of the proximal lift arm and distal lift arm.

9. A spraying module according to claim 1, further comprising a height adjustment arrangement configured to receive input from a user to adjust the height of a first part of the height adjustment arrangement to which the spraying nozzle is attached relative to the height of a second part of the height adjustment arrangement.

10. A self-propelled autonomous marking robot for marking the ground of a sports field, the self-propelled autonomous marking robot comprising:
a propulsion system,
at least one drive wheel connected to the propulsion system,
at least one additional wheel,
a reservoir configured to contain a marking material,
a dispensing system comprising tubing and at least one actuator, the dispensing system being configured to move marking material from the reservoir to an outlet of the tubing,
a control system comprising a central processing unit and a memory and configured to controlling the dispensing system, and
a spraying module according to claim 1, configured to receive the marking material from the outlet of the tubing.

11. A self-propelled autonomous marking robot according to claim 10, further comprising a mechanical connector, which is releasably connectable to the mechanical connector of the spraying module.

12. A self-propelled autonomous marking robot according to claim 10, wherein the control system is configured to lift or lower the discs of the spraying module by controlling an actuator to rotate the lift arms about the pivot axis.

13. A self-propelled autonomous marking robot according to claim 12, wherein the actuator is configured for rotating a connector shaft of the spraying module to rotate the lift arms.
